(19) United States
(12) Patent Application Publication
(10) Pub. No.: US 2022/0153253 A1
(43) Pub. Date: May 19, 2022

(54) CONTROL DEVICE FOR VEHICLE

(71) Applicant: HONDA MOTOR CO., LTD., Tokyo (JP)

(72) Inventor: Takanori NAKASHIMA, Tokyo (JP)

(73) Assignee: HONDA MOTOR CO., LTD., Tokyo (JP)

(21) Appl. No.: 17/509,553

(22) Filed: Oct. 25, 2021

(30) Foreign Application Priority Data
Nov. 13, 2020 (JP) 2020-189609

(51) Int. Cl. B60W 20/20; B60W 20/13; B60W 10/06; B60W 10/08; B60W 10/26

(52) U.S. Cl. CPC B60W 20/20; B60W 20/13; B60W 10/06; B60W 10/08; B60W 2710/083; B60W 2510/244; B60W 2520/28; B60W 2556/50; B60W 2710/244; B60W 10/26

(57) ABSTRACT

A vehicle can take a hybrid driving mode in which the vehicle drives by power output by a first motor generator in response to power supply from at least a second motor generator, and an engine driving mode in which the vehicle drives by power output by at least an engine. When a high load section requiring an assist by the first motor generator is detected in the route on which the vehicle is driving in the engine driving mode, a control device of the vehicle predicts the remaining capacity of the battery in the high load section, and based on the remaining capacity, the control device can control the battery in the high load section before reaching the high load section, based on the remaining capacity of the battery in the high load section, and switch to the hybrid driving mode before reaching the high load section.

### CROSS-REFERENCE TO RELATED APPLICATIONS

The present application claims the benefit of priority of Japanese Patent Application No. 2020-189609, filed on Nov. 13, 2020, the content of which is incorporated herein by reference.

### TECHNICAL FIELD

The present invention relates to a control device for a vehicle having a plurality of driving modes.

### BACKGROUND ART

Japanese Patent No. 5624995 discloses a control method of a hybrid vehicle in which a power transmission connection/disconnection portion can be engaged without generating a shock when shifting from series traveling using an electric motor as a drive source to engine direct connection traveling using at least an internal combustion engine as a drive source. In the control method of the vehicle, when a rotational speed of a power generator coincides with a rotational speed of the internal combustion engine, signs of angular velocities of the respective rotational speeds coincide with each other, and the output of the internal combustion engine via the power generator coincides with the output of the electric motor, a clutch is engaged so as not to generate a shock.

### SUMMARY OF INVENTION

In related art, for example, when a vehicle travels in a high load section such as an uphill slope, a driving mode is switched, and a rapid fluctuation in a rotation speed of an internal combustion engine may occur due to switching of the driving mode, and there is room for improvement from the viewpoint of noise and vibration (NV) characteristics of the vehicle.

An object of the present embodiment is to provide a control device for a. vehicle that can prevent the occurrence of a rapid fluctuation in the rotational speed of an internal combustion engine due to switching of a driving mode in a high load section and improving the marketability of the vehicle.

The present embodiment provides a control device for a vehicle, the vehicle configured to travel on under a plurality of driving modes, and the vehicle including:

an internal combustion engine;

a power generator driven by the internal combustion engine and configured to generate electric power;

an electric storage device configured to store electric power generated by the power generator;

an electric motor connected to the power generator and the electric storage device and configured to drive a drive wheel by electric power supplied from at least one of the power generator and the electric storage device;

the drive wheel driven by at least one of the internal combustion engine and the electric motor; and

a disconnection/connection portion configured to disconnect and connect a power transmission path between the internal combustion engine and the drive wheel, and

the plurality of driving modes including:

a first driving mode in which the power transmission path is disconnected by the disconnection/connection portion, and the drive wheel is driven and caused to travel by the power output from the electric motor at least in accordance with the electric power supplied from the power generator; and

a second driving mode in which the power transmission path is connected by the disconnection/connection portion and the drive wheel is driven and caused to travel by at least the power output from the internal combustion engine, wherein

when a high load section in which driving of the drive wheel is assisted by the electric motor is detected in a scheduled traveling route of the vehicle traveling on under the second driving mode, a state of charge of the electric storage device in the high load section is predicted, and

switching to the first driving mode is performed before the vehicle reaches the high load section based on the predicted state of charge.

According to the present embodiment, it is possible to provide a control device for a vehicle that can prevent the occurrence of a rapid fluctuation in a rotational speed of an internal combustion engine due to switching of a driving mode in a high load section and improving the marketability of the vehicle.

### BRIEF DESCRIPTION OF DRAWINGS

FIG. 1 is a diagram showing a schematic configuration of a vehicle according to an embodiment,

FIG. 2 is a flowchart (part 1) showing an example of control processing of a driving mode by a control device according to the present embodiment.

FIG. 3 is a flowchart (part 2) showing an example of the control processing of the driving mode by the control device according to the present embodiment.

FIG. 4 is a diagram showing a first example of specific control by the control device according to the present embodiment.

FIG. 5 is a diagram showing a second example of the specific control by the control device according to the present embodiment.

### DESCRIPTION OF EMBODIMENTS

Hereinafter, an embodiment of a control device for a vehicle according to the present invention will be described in detail with reference to the drawings.

[Vehicle]

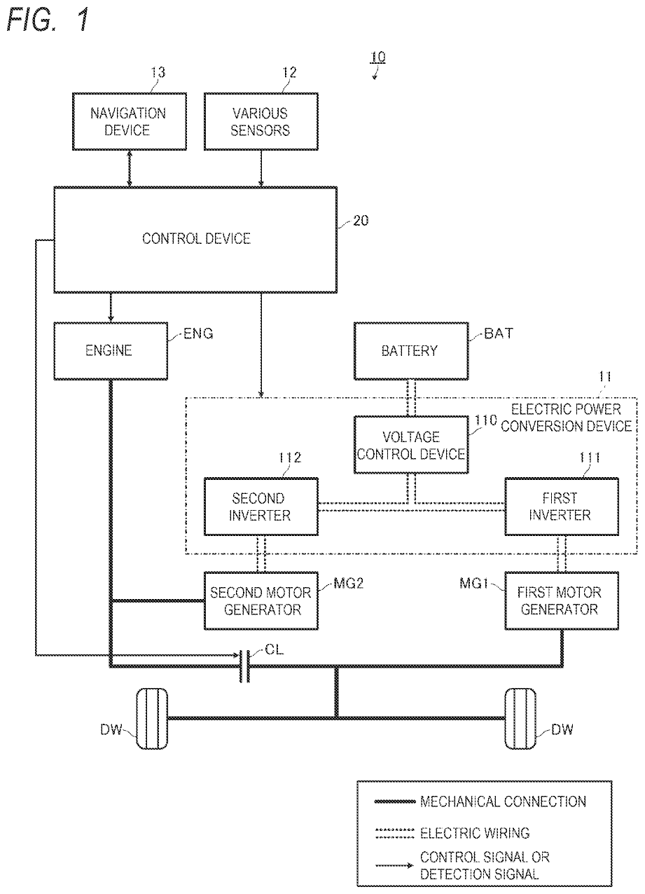

First, a vehicle according to the present embodiment will be described. As shown in FIGS. 1, a vehicle 10 is a hybrid electric vehicle, and includes an engine ENG, a first motor generator MG1, a second motor generator MG2, a battery BAT, a clutch CL, an electric power conversion device 11, various sensors 12, a navigation device 13, and a control device 20 which is an example of a control device according to the present embodiment. In FIG. 1, thick solid lines each indicate a mechanical connection, double dotted lines each indicate an electric wiring, and thin solid line arrows each indicate transmission and reception of a control signal or a detection signal.

The engine ENG is, for example, a gasoline engine or a diesel engine, and outputs power generated by burning supplied fuel. The engine ENG is connected to the second motor generator MG2 and is connected to a drive wheel DW of the vehicle 10 via the clutch CL. Power output from the engine ENG (hereinafter also referred to as “output of the engine ENG”) is transmitted to the second motor generator MG2 in a case where the clutch CL is in a disconnected state, and is transmitted to the second motor generator MG2 and the drive wheel DW in a case where the clutch CL is in a connected state (engaged state). The second motor generator MG2 and the clutch CL will be described later.

The first motor generator MGI is a motor generator (a so-called drive motor) mainly used as a drive source of the vehicle 10, and includes, for example, an alternating-current motor. The first motor generator MGI is electrically connected to the battery BAT and the second motor generator MG2 via the electric power conversion device 11. The electric power of at least one of the battery BAT and the second motor generator MG2 may be supplied to the first motor generator MG1. The first motor generator MG1 operates as an electric motor by being supplied with electric power, and outputs power for the vehicle 10 to travel. The first motor generator MG1 is coupled to the drive wheel DW, and power output from the first motor generator MGI (hereinafter, also referred to as “output of the first motor generator MG1”) is transmitted to the drive wheel DW. The vehicle 10 travels by transmitting (that is, supplying) at least one of the output of the engine ENG and the output of the first motor generator MG1 to the drive wheel DW.

In addition, the first motor generator MG1 performs a regenerative operation as a power generator when the vehicle 10 is braked (when the vehicle 10 is rotated by the engine ENG or the drive wheel DW) to generate electric power (so-called regenerative power generation). Electric power generated by the regenerative operation of the first motor generator MG1 (hereinafter, also referred to as “regenerative electric power”) is supplied to the battery BAT via the electric power conversion device 11, for example. As a result, the battery BAT can be charged by the regenerative electric power

The regenerative electric power may not be supplied to the battery BAT, and may be supplied to the second motor generator MG2 via the electric power conversion device 11, By supplying the regenerative electric power to the second motor generator MG2, it is possible to perform “waste electricity” in which the regenerative electric power is consumed without charging the battery BAT. At the time of waste electricity, the regenerative electric power supplied to the second motor generator MG2 is used for driving the second motor generator MG2, and power generated thereby is input to the engine ENG to be consumed by mechanical friction loss of the engine ENG and the like.

The second motor generator MG2 is a motor generator (a so-called power generation motor) mainly used as a power generator, and includes, for example, an alternating-current motor. The second motor generator MG2 is driven by the power of the engine ENG to generate electric power. The electric power generated by the second motor generator MG2 is supplied to at least one of the battery BAT and the first motor generator MG1 via the electric power conversion device 11. By supplying the electric power generated by the second motor generator MG2 to the battery BAT, the battery BAT can be charged by the electric power, In addition, by supplying the electric power generated by the second motor generator MG2 to the first motor generator MG1, the first motor generator MG1 can be driven by the electric power.

The electric power conversion device 11 is a device (also referred to as a so-called power control unit “PCU”) that converts input electric power and outputs the converted electric power, and is connected to the first motor generator MG1, the second motor generator MG2, and the battery BAT. For example, the electric power conversion device 11 includes a. first inverter 111, a second inverter 112, and a voltage control device 110. The first inverter 111, the second inverter 112, and the voltage control device 110 are electrically connected to each other.

The voltage control device 110 converts an input voltage and outputs the converted voltage. A DC/DC converter or the like can be used as the voltage control device 110. For example, when the electric power of the battery BAT is supplied to the first motor generator MG1, the voltage control device 110 boosts the output voltage of the battery BAT and outputs the boosted output voltage to the first inverter 111. For example, when the regenerative power generation is performed by the first motor generator MG1, the voltage control device 110 steps down the output voltage of the first motor generator MGI received via the first inverter 111 and outputs the stepped-down output voltage to the battery BAT. When electric power is generated by the second motor generator MG2, the voltage control device 110 steps down the output voltage of the second motor generator MG2 received via the second inverter 112 to output the electric power to the battery BAT.

When the electric power of the battery BAT is supplied to the first motor generator MG1, the first inverter 111 converts the electric power (direct current) of the battery BAT received via the voltage control device 110 into an alternating current and outputs the alternating current to the first motor generator MG1. When the first motor generator MG1 performs the regenerative power generation, the first inverter 111 converts the electric power (alternating current) received from the first motor generator MG1 into a direct current and outputs the direct current to the voltage control device 110. When the regenerative electric power of the first motor generator MG1 is wasted, the first inverter 111 converts the electric power (alternating current) received from the first motor generator MG1 into a direct current and outputs the direct current to the second inverter 112.

When electric power is generated by the second motor generator MG2, the second inverter 112 converts the electric power (alternating current) received from the second motor generator MG2 into a direct current and outputs the direct current to the voltage control device 110. When the regenerative electric power of the first motor generator MG1 is wasted, the second inverter 112 converts the regenerative electric power (direct current) of the first motor generator MGI received via the first inverter 111 into an alternating current and outputs the alternating current to the second motor generator MG2.

The battery BAT is a chargeable and dischargeable secondary battery, and includes a plurality of power storage cells connected in series or in series and parallel. The battery BAT may be configured to output a high voltage of, for example, 100 [V] to 400 [V]. As the power storage cell of the battery BAT, a lithium ion battery, a nickel hydrogen battery, or the like can be used.

The clutch CL can take a connected state in which a power transmission path from the engine ENG to the drive wheel DW is connected (engaged), and a disconnected state in which the power transmission path from the engine ENG to the drive wheel DW is disconnected (blocked). The output of the engine ENG is transmitted to the drive wheel DW when the clutch CL is in the connected state, and is not transmitted to the drive wheel DW when the clutch CL is in the disconnected state.

The various sensors 12 include, for example, a vehicle speed sensor that detects a speed of the vehicle 10 (hereinafter, also referred to as a “vehicle speed”), an accelerator position (hereinafter, also referred to as an “AP”) sensor that detects an operation amount of the vehicle 10 with respect to an accelerator pedal, and a battery sensor that detects various types of information on the battery BAT (for example, the output voltage of the battery BAT, a charge and discharge current, and a temperature). Detection results of the various sensors 12 are transmitted to the control device 20 as detection signals.

The navigation device 13 includes a storage device (for example, a flash memory) that stores map data and the like, a global navigation satellite system (GLASS) receiver that can specify a position of the vehicle 10 (hereinafter also referred to as a “host vehicle position”) based on a signal received from a positioning satellite, a display that displays various types of information, an operation button (including a touch panel) that receives an operation from a user (for example, a driver of the vehicle) 10, and the like.

The map data stored in the navigation device 13 includes road data related to a road. In the road data, each road is divided into predetermined sections. The road data includes information on links corresponding to the sections and nodes connecting the links. In the road data, attribute information indicating a distance of a section corresponding to each link, a regulated speed (for example, a legal speed), a road gradient (for example, an inclination angle), and the like is provided in association with each link.

For example, the navigation device 13 determines a route (hereinafter, also referred. to as a “guidance route”) from the host vehicle position, which is the current location of the vehicle 10, to a destination set by the user of the vehicle 10 with reference to map data or the like, and guides the user by displaying the determined guidance route on a display.

The navigation device 13 predicts a scheduled traveling route of the vehicle 10 with reference to the host vehicle position, a traveling direction of the vehicle 10, the set destination, the map data, and the like. As an example, the navigation device 13 predicts a. section (for example, a section from the host vehicle position to 10 [km] ahead in the traveling direction) within a predetermined range ahead of (that is, in front of) the traveling direction of the vehicle 10 from the host vehicle position as the scheduled traveling route.

When the scheduled traveling route is predicted, the navigation device 13 transmits route information on the scheduled traveling route to the control device 20. The route information includes information indicating each section included in the scheduled traveling route and the attribute information of each section. Thus, the navigation device 13 can notify the control device 20 of each section included in the scheduled traveling route, the regulated speed, the road gradient, and the like of the section. In addition, the navigation device 13 also notifies the control device 20 of the host vehicle position as appropriate.

Further, the navigation device 13 may be configured to receive road traffic information including congestion information, and may transmit the received road traffic information to the control device 20. In this way, the navigation device 13 can notify the control device 20 of a congestion situation or the like of the scheduled traveling route.

The control device 20 is provided so as to communicate with the engine ENG, the clutch CL, the electric power conversion device 11, the various sensors 12, and the navigation device 13. The control device 20 controls the output of the engine ENG, controls the output of the first motor generator MG1 and the second motor generator MG2 by controlling the electric power conversion device 11, and controls the state of the clutch CL. Accordingly, the control device 20 can control the driving mode of the vehicle 10 when traveling on the scheduled traveling route according to the route situation or the like, as will be described later,

The control device 20 can be implemented by, for example, an electronic control unit (ECU) including a processor that performs various calculations, a storage device that stores various types of information, an input/output device that controls input and output of data between the inside and the outside of the control device 20, and the like. The control device 20 may be implemented by one ECU or may be implemented by a plurality of ECUs.

[Driving mode of Vehicle]

Next, the driving mode of the vehicle 10 will be described. The vehicle 10 can take an EV driving mode, a hybrid driving mode, and an engine driving mode as the driving modes. Further, the vehicle 10 travels on under any one of the driving modes. Which driving mode the vehicle 10 travels on under is controlled by the control device 20.

[EV Driving mode]

The EV driving mode is a driving mode in which only the electric power of the battery BAT is supplied to the first motor generator MG1 and the vehicle 10 travels by the power output from the first motor generator MG1 in accordance with the electric power.

Specifically, in a case of the EV driving mode, the control device 20 brings the clutch CL into the disconnected state. In addition, in the case of the EV driving mode, the control device 20 stops the supply of the fuel to the engine ENG (performs so-called fuel cut), and stops the output of the power from the engine ENG. Therefore, in the EV driving mode, power generation by the second motor generator MG2 is not performed. In the case of the EV driving mode, the control device 20 performs a control so that only the electric power of the battery BAT is supplied to the first motor generator MG1, and the first motor generator MG1 outputs power corresponding to the electric power to cause the vehicle 10 to travel by the power

The control device 20 performs a control so that the vehicle 10 travels on under the EV driving mode on a condition that only the electric power from the battery BAT is supplied to the first motor generator MG1 and the driving force required for the travel of the vehicle 10 (hereinafter, also referred to as “required driving force”) is obtained by the power output from the first motor generator MG1 in accordance with the electric power.

In the EV driving mode, since the supply of the fuel to the engine ENG is stopped, the fuel consumed by the engine ENG is reduced and a fuel efficiency of the vehicle 10 is improved as compared with the other driving modes in which the fuel is supplied to the engine ENG. Therefore, it is possible to improve the fuel efficiency of the vehicle 10 by increasing a frequency (opportunity) of setting the vehicle 10 in the EV driving mode. In the EV driving mode, since the second motor generator MG2 does not generate electric power, and the first motor generator MG1 is driven only by the electric power of the battery BAT, a state of charge (SOC) of the battery BAT tends to decrease.

[Hybrid Driving Mode]

The hybrid driving mode is a driving mode in which at least electric power generated by the second motor generator MG2 is supplied to the first motor generator MGI, and the vehicle 10 is mainly caused to travel by the power output from the first motor generator MGI in accordance with the electric power.

Specifically, in a case of the hybrid driving mode, the control device 20 brings the clutch CL into the disconnected state. In addition, in the case of the hybrid driving mode, the control device 20 performs a control so that the fuel is supplied to the engine ENG, and the engine ENG outputs the power to drive the second motor generator MG2 by the power of the engine ENG. Accordingly, in the hybrid driving mode, the electric power is generated by the second motor generator MG2. In the case of the hybrid driving mode, the control device 20 performs a control so that the power transmission path is in the disconnected state by the clutch CL, the electric power generated by the second motor generator MG2 is supplied to the first motor generator MG1, and the first motor generator MG1 outputs power corresponding to the electric power to cause the vehicle 10 to travel by the power.

The electric power supplied from the second motor generator MG2 to the first motor generator MG1 is larger than the electric power supplied from the battery BAT to the first motor generator MG1. Therefore, in the hybrid driving mode, as compared with the EV driving mode, the output of the first motor generator MG1 can be increased, and a large driving force can be obtained as a driving force for causing the vehicle 10 to travel (hereinafter, also referred to as “output of the vehicle 10”).

In the case of the hybrid driving mode, the control device 20 may also cause the electric power of the battery BAT to be supplied to the first motor generator MG1 as necessary. That is, in the hybrid driving mode, the control device 20 may cause both the electric power of the second motor generator MG2 and the electric power of the battery BAT to be supplied to the first motor generator MG1. Accordingly, as compared with the case where only the electric power of the second motor generator MG2 is supplied to the first motor generator MGI, the electric power supplied to the first motor generator MG1 can be increased, and a larger driving force can be obtained as the output of the vehicle 10. Note that the hybrid driving mode is an example of a first driving mode in the present embodiment.

[Engine Driving Mode]

The engine driving mode is a driving mode in which the vehicle 10 is mainly caused to travel by the power output from the engine ENG.

Specifically, in a case of the engine driving mode, the control device 20 brings the clutch CL into the connected state. In the case of the engine driving mode, the control device 20 performs a control so that the fuel is supplied to the engine ENG, and the power is output from the engine ENG. In the case of the engine driving mode, since the power transmission path is in the connected state by the clutch CL, the power of the engine ENG is transmitted to the drive wheel DW to drive the drive wheel DW. As described above, in the case of the engine driving mode, the control device 20 performs a control so that the power is output from the engine ENG, and the vehicle 10 is caused to travel by the power.

In the case of the engine driving mode, the control device 20 may also cause the electric power of the battery BAT to be supplied to the first motor generator MG1 as necessary. Accordingly, in the engine driving mode, the vehicle 10 can also travel using the power output from the first motor generator MG1 by the supply of the electric power of the battery BAT, and a larger driving force can be obtained as the output of the vehicle 10 as compared with the case where the vehicle 10 is caused to travel only by the power of the engine ENG. As a result, the output of the engine ENG can be prevented and the fuel efficiency of the vehicle 10 can be improved as compared with the case where the vehicle 10 is driven only by the power of the engine ENG.

In this way, in the engine driving mode, the traveling of the vehicle 10 using the power output from the first motor generator MGI, that is, assisting the driving of the drive wheel DW by the first motor generator MG1, is also referred to as “assist by the first motor generator MG1”. Note that the engine driving mode is an example of a second driving mode in the present embodiment.

[Example of Control Processing of Driving Mode]

Next, an example of the control processing of the driving mode performed by the control device 20 will be described. For example, when the vehicle 10 is in the travelable state (for example, when the ignition power supply of the vehicle 10 is turned on), the control device 20 performs the following control processing of the driving mode. Note that the control processing can be implemented, for example, by a processor of the control device 20 executing a program stored in advance in the storage device.

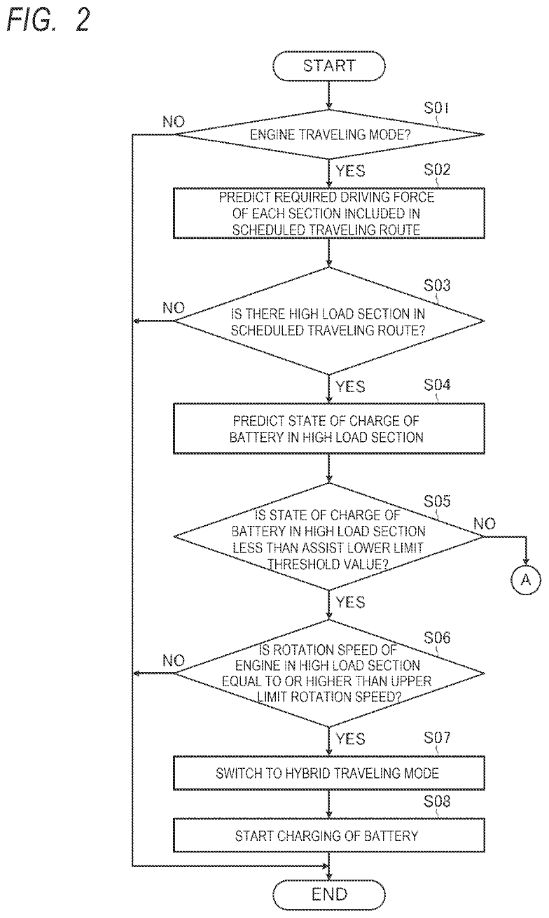

As shown in FIG. 2, the control device 20 determines whether the current driving mode of the vehicle i0 is the engine driving mode (step S01). When it is determined in step S01 that the driving mode is not the engine driving mode (NO in step S01), the control device 20 ends the control processing of the driving mode in the present example.

On the other hand, when it is determined in step S01 that the driving mode is the engine driving mode (YES in step S01), the control device 20 predicts the required driving force of each section included in the scheduled traveling route of the vehicle 10 based on the route information received from the navigation device 13 (step S02). The required driving force of each section can be predicted based on, for example, the speed of the vehicle 10 (for example, a legal speed) when the vehicle 10 travels in each section, the road gradient of each section.

Next, the control device 20 determines whether there is a high load section in the scheduled traveling route of the vehicle 10 based on the required driving force of each section predicted in step S02 (step S03). Here, the high load section is a section in which the required driving force is larger than a threshold value. Specifically, the high load section is, for example, a section in which assistance by the first motor generator MG1 is necessary when the vehicle 10 travels on under the engine driving mode. Here, the necessity of the assist by the first motor generator MG1 means that, for example, an execution condition of the assist by the first motor generator MG1, which is set based on the viewpoint of fuel efficiency, NV characteristics, and the like of the vehicle 10, is satisfied.

In step S03, when it is determined that there is no high load section in the scheduled traveling route of the vehicle 10 (NO in step S03), the control device 20 ends the control processing of the driving mode in the present example. On the other hand, when it is determined in step S03 that there is a high load section in the scheduled traveling route of the vehicle 10 (YES in step S03), the control device 20 predicts the state of charge of the battery BAT in the high load section in the scheduled traveling route of the vehicle 10 (hereinafter, also simply referred to as “high load section”) (step S04).

Specifically, in step S04, the control device 20 predicts the state of charge of the battery BAT when the vehicle 10 travels in the high load section on under the engine driving mode while being assisted by the first motor generator MG1. For example, the “driving force required for assistance by the first motor generator MG1 in the high load section” can be calculated by subtracting an “upper limit value of the output of the vehicle 10 obtained only by the engine ENG under conditions allowed from the viewpoint of fuel efficiency, NV characteristics, and the like of the vehicle 10 in the engine driving mode” from the “required driving force in the high load section”. Then, in order to obtain the “driving force required for assistance by the first motor generator MG1 in the high load section”, the control device 20 can predict the state of charge of the battery BAT when the vehicle 10 travels in the high load section in the engine driving mode while being assisted by the first motor generator MG1 by subtracting the electric power required to be supplied from the battery BAT to the first motor generator MG1 from the current state of charge of the battery BAT. The control device 20 is not limited to the example described here, and may predict the state of charge of the battery BAT in the high load section using any method.

Next, the control device 20 determines whether the state of charge of the battery BAT in the high load section predicted in step S04 is less than an assist lower limit threshold value (step S05). Here, the assist lower limit threshold value is a lower limit value of the state of charge of the battery BAT determined as a condition under which the assist by the first motor generator MGI can be executed. That is, the control device 20 performs a control so that the assist by the first motor generator MG1 is performed on the condition that the state of charge of the battery BAT is equal to or greater than the assist lower limit threshold value. The assist lower limit threshold value is set in advance in the control device 20.

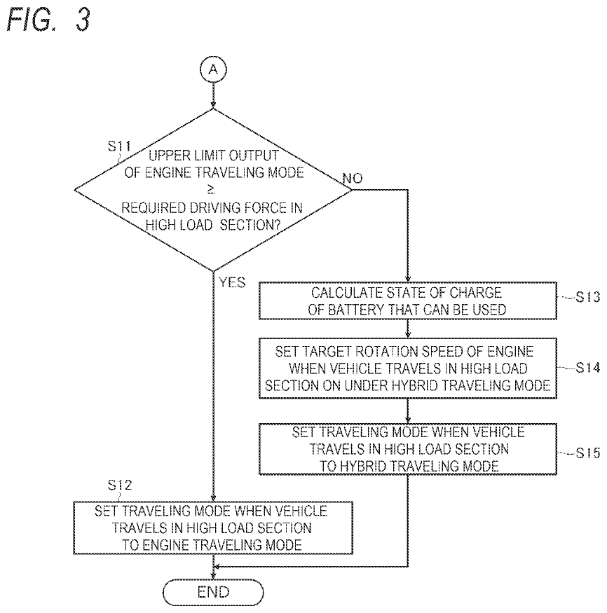

In step S05, when it is determined that the state of charge of the battery BAT in the high load section is not less than the assist lower limit threshold value (NO in step S05), the control device 20 proceeds to step S11 of the flowchart shown in FIG. 3. The flowchart in FIG. 3 will be described later.

On the other hand, when it is determined in step SO5 that the state of charge of the battery BAT in the high load section is less than the assist lower limit threshold value (YES in step S05), the control device 20 proceeds to step S06. In step S06, the control device 20 predicts the rotation speed of the engine ENG when the vehicle 10 travels in the high load section by the output of the vehicle 10 obtained only by the engine ENG in the engine driving mode. Then, the control device 20 determines whether the rotation speed of the engine ENG in the predicted high load section is equal to or higher than a predetermined rotation speed (hereinafter, also referred to as an “upper limit rotation speed”) (step S06). The upper limit rotation speed is, for example, a rotation speed determined as a so-called revolution limit. In addition, the upper limit rotation speed is not limited to the revolution limit, and may be a rotation speed (for example, a rotation speed lower than the revolution limit) determined in consideration of the NV characteristics of the vehicle 10 and the like. The upper limit rotation speed is set in advance in the control device 20.

For example, it is assumed that the state of charge of the battery BAT is less than the assist lower limit threshold value when the vehicle 10 is traveling in the high load section on under the engine driving mode while being assisted by the first motor generator MG1. In this case, when the state of charge of the battery BAT is less than the assist lower limit threshold value, the assist by the first motor generator MG1 is stopped. When the assist by the first motor generator MG1 is stopped in this way, it is assumed that the rotation speed of the engine ENG is increased in order to secure the required driving force for traveling in the high load section. In step S06, the control device 20 determines whether the rotation speed of the engine ENG expected to increase in this way is equal to or higher than the upper limit rotation speed.

In step S06, when it is determined that the rotation speed of the engine ENG is not equal to or higher than the upper limit rotation speed (NO in step S06), the control device 20 ends the control processing of the driving mode in the present example. In this case, the process of step S07, which will be described later, is not performed, and, for example, the driving mode is maintained in the engine driving mode.

On the other hand, when it is determined in step S06 that the rotation speed of the engine ENG is equal to or higher than the upper limit rotation speed (YES in step S06), the control device 20 switches the driving mode of the vehicle 10 from the engine driving mode to the hybrid driving mode before the vehicle 10 reaches the high load section (step S07). In this case, the control device 20 switches the driving mode to the hybrid driving mode at a. predetermined timing before the vehicle 10 reaches the high load section, and causes the vehicle 10 to travel in the high load section on under the hybrid driving mode. The timing of switching to the hybrid driving mode may be determined, for example, based on parameters such as the distance from the host vehicle position to the high load section, the vehicle speed, and the congestion situation. This makes it possible to start switching to the hybrid driving mode at an appropriate timing.

When the driving mode is switched to the hybrid driving mode, the control device 20 starts charging of the battery BAT with the electric power generated by the second motor generator MG2 (step S08). For example, the control device 20 starts the charging of the battery BAT by increasing the output of the engine ENG in order to cause the second motor generator MG2 to generate electric power larger than the electric power consumed by the first motor generator MG1. Accordingly, it is possible to charge the battery BAT by the electric power generated by the second motor generator MG2 while ensuring the electric power consumed by the first motor generator MG1 and maintaining the output of the vehicle 10.

In this way, the control device 20 starts the charging of the battery BAT before the vehicle 10 reaches the high load section, so that the state of charge of the battery BAT (that is, the electric power that can be supplied from the battery BAT to the first motor generator MG1) when the vehicle 10 travels in the high load section can be secured in advance in a large amount.

The control device 20 may start the charging of the battery BAT at the same time as the switching to the hybrid driving mode, or may start the charging of the battery BAT at a predetermined timing after the switching to the hybrid driving mode. In this case, a timing at which the charging of the battery BAT is started may be determined based on parameters such as the distance from the host vehicle position to the high load section, the vehicle speed, the congestion situation, and the state of charge of the battery BAT As a result, the charging of the battery BAT can be started at an appropriate timing,

When the battery BAT is charged, the control device 20 preferably increases the output of the engine ENG within a range in which the rotation speed of the engine ENG does not exceed a predetermined value, Here, the predetermined value is a rotation speed determined in consideration of the NV characteristics of the vehicle 10 and the like. Accordingly, the control device 20 can prevent deterioration of the NV characteristics of the vehicle 10 at the time of charging the battery BAT.

As described above, when the state of charge of the battery BAT in the high load section is less than the assist lower limit threshold value, the control device 20 can switch the driving mode to the hybrid driving mode before the vehicle 10 reaches the high load section and cause the vehicle 10 to travel in the high load section on under the hybrid driving mode. Thus, in the high load section, it is possible to prevent the occurrence of a rapid fluctuation in the rotation speed of the engine ENG due to the state of charge of the battery BAT being less than the assist lower limit threshold value and the assist by the first motor generator MG1 being stopped. Therefore, it is possible to prevent deterioration of the NV characteristics of the vehicle 10 due to the rapid fluctuation in the rotation speed of the engine ENG, and it is possible to improve the marketability of the vehicle 10.

Further, even when the assist by the first motor generator MG1 is stopped in the high load section, it is assumed that the rotation speed of the engine ENG does not reach the upper limit rotation speed when the required driving force in the high load section is relatively small. In such a case, even when the assist by the first motor generator MG1 is stopped in the high load section, it is assumed that the fluctuation in the rotation speed of the engine ENG is relatively small or the rotation speed of the engine ENG is kept relatively low. That is, in such a case, even when the assist by the first motor generator MG1 is stopped in the high load section, it is assumed that the NV characteristic of the vehicle 10 does not deteriorate.

Therefore, even when the state of charge of the battery BAT in the high load section is less than the assist lower limit threshold value, the control device 20 performs a control so that the driving mode is maintained in the engine driving mode and the vehicle travels in the high load section on under the engine driving mode when the rotation speed of the engine ENG in the high load section is less than the upper limit rotation speed. As a result, it is possible to prevent the occurrence of the fluctuation in the rotation speed of the engine ENG due to the switching from the engine driving mode to the hybrid driving mode. In addition, for example, by causing the vehicle to travel in the high load section on under the engine driving mode, it is possible to prevent heat generation of the electric power conversion device 11 and the like as compared with a case where the vehicle travels in the high load section on under the hybrid driving mode.

As described above, the control device 20 performs a control so that the vehicle 10 travels in the high load section on under an appropriate driving mode by switching to the hybrid driving mode or maintaining the engine driving mode depending on whether the rotation speed of the engine ENG reaches the upper limit rotation speed in a case where the state of charge of the battery BAT is less than the assist lower limit threshold value and the assist by the first motor generator MG1 cannot be performed in the high load section.

Next, a case where it is determined in step SO5 that the state of charge of the battery BAT in the high load section is not less than the assist lower limit threshold value will be described. When it is determined that the state of charge of the battery BAT in the high load section is not less than the assist lower limit threshold value (NO in step S05), as shown in FIG. 3, the control device 20 determines whether the maximum value of the output of the vehicle 10 obtained in the engine driving mode (hereinafter, also referred to as “upper limit output of the engine driving mode”) is equal to or greater than the required driving force in the high load section (step S11).

In step S11, when it is determined that the upper limit output of the engine driving mode is equal to or greater than the required driving force of the high load section (YES in step S11), the control device 20 sets the driving mode of the vehicle 10 when the vehicle 10 travels in the high load section to the engine driving mode (step S12). In this case, the control device 20 causes the vehicle 10 to travel in the high load section on under the engine driving mode, for example, by maintaining the current engine driving mode as it is until the vehicle 10 passes through the high load section. In this case, the control device 20 only needs to set the driving mode when the vehicle 10 passes through the high load section to the engine driving mode, and for example, cause the vehicle 10 to travel on under a driving mode other than the engine driving mode in any section, for example, between the host vehicle position and the high load section.

On the other hand, when it is determined in step S11 that the upper limit output of the engine driving mode is not equal to or greater than the required driving force of the high load section (NO in step S11), the control device 20 calculates the state of charge of the battery BAT that can be used (step S13). Here, the state of charge of the battery BAT that can be used can be calculated, for example, by subtracting the assist lower limit threshold. value described above from the current state of charge of the battery BAT.

Next, based on the state of charge of the battery that can be used and calculated in step S13, the control device 20 sets a target rotation speed of the engine ENG when the vehicle travels in the high load section on under the hybrid driving mode (step S14).

In step S14, for example, the control device 20 first predicts the power consumption of the vehicle 10 (for example, the first motor generator MG1) when the vehicle 10 travels in the high load section on under the hybrid driving mode, based on the required driving force of the high load section. Next, the control device 20 calculates the electric power required to be generated by the second motor generator MG2 in the high load section based on the electric power consumption when the vehicle travels on under the hybrid driving mode in the predicted high load section and the state of charge of the battery that can be used and calculated in step S13. At this time, the control device 20 calculates the electric power required to be generated in the high load section, assuming that all the states of charge of the battery that can be used and calculated in step S13 is used up in the high load section. As a result, the electric power required to be generated in the high load section can be reduced as much as possible. Then, the control device 20 sets, as the target rotation speed, the minimum rotation speed of the engine ENG that can cause the second motor generator MG2 to generate electric power that is required to be generated in the high load section. By making the electric power required for power generation as small as possible in the high load section, the rotation speed of the engine ENG set as the target rotation speed can be lowered. Accordingly, it is possible to improve the marketability of the vehicle 10 from the viewpoint of the fuel efficiency, the NV characteristics, and the like.

Next, the control device 20 sets the driving mode of the vehicle 10 when the vehicle 10 travels in the high load section to the hybrid driving mode (step S15). In this case, the control device 20 switches the driving mode to the hybrid driving mode at a timing at which the vehicle 10 reaches the high load section or at any timing before the vehicle 10 reaches the high load section, and causes the vehicle 10 to travel in the high load section on under the hybrid driving mode. When the vehicle travels in the high load section on under the hybrid driving mode, the control device 20 performs a control so that the engine ENG is operated in accordance with the target rotation speed set in step 514, and the electric power generated by the second motor generator MG2 and the electric power of the battery BAT are supplied to the first motor generator MG1 by the power of the engine ENG.

[First Example of Specific Control by Control Device]

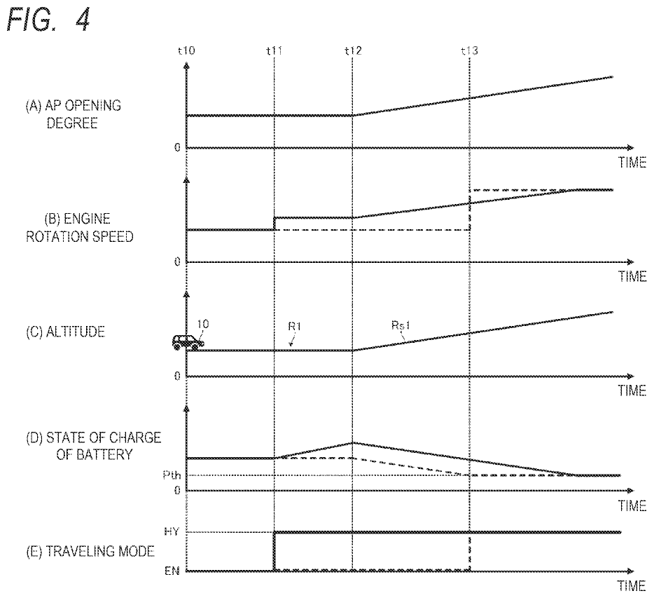

Next, a first example of specific control by the control device 20 will be described with reference to FIG. 4. In the example shown in FIG. 4, it is assumed that the vehicle 10 travels on a route R1 at a constant speed V1 (for example, 40 [km/h]). Here, the route R1 is a route predicted as a scheduled traveling route of the vehicle 10.

At a time t10 at which the vehicle 10 is traveling on the route RI on under an engine driving mode (shown as driving mode “EN”), the control device 20 detects that a high load section Rs1 is present on the route R1 based on the required driving force of each section included in the route R1. Then, the control device 20 determines that the state of charge of the battery BAT in the high load section Rs1 is less than an assist lower limit threshold value Pth.

In this case, the control device 20 switches the driving mode of the vehicle 10 from the engine driving mode to a hybrid driving mode (shown as a driving mode “HY”) at a time t11 (for example, a time immediately after the time t10) before a time t12 at which the vehicle 10 reaches the high load section Rs1 (see (E) in FIG. 4). By switching to the hybrid driving mode, the electric power generated by the second motor generator MG2 is supplied to the first motor generator MG1, and the vehicle 10 travels by the power output from the first motor generator MG1. At the time tit, since the section in which the vehicle 10 is traveling is not the high load section, only the electric power generated by the second motor generator MG2 is supplied to the first motor generator MG1.

When the driving mode of the vehicle 10 is switched to the hybrid driving mode, the control device 20 starts charging of the battery BAT with the electric power generated by the second motor generator MG2 (see (D) FIG. 4).

Thereafter, at the time t12, when the vehicle 10 reaches the high load section Rs1, a driver of the vehicle 10 increases the operation amount (that is, AP opening degree) of an accelerator pedal by more strongly depressing the accelerator pedal of the vehicle 10 or the like in order to maintain the speed of the vehicle 10 at V1 (see (A) in FIG. 4). As a result, the required driving force for the vehicle 10 is increased. Therefore, from the time 112, the control device 20 performs a control so that the electric power of the battery BAT is also supplied to the first motor generator MG1 in addition to the electric power generated by the second motor generator MG2.

When the state of charge of the battery BAT is decreased by supplying the electric power of the battery BAT to the first motor generator MG1, the output (for example, the output voltage) of the battery BAT is also decreased accordingly. As a result, the electric power supplied from the battery BAT to the first motor generator MG1 per unit time may be decreased, and the output of the first motor generator MG1 may be decreased.

Therefore, as shown in (B) in FIG. 4, for example, the control device 20 increases the rotation speed of the engine ENG when the vehicle travels in the high load section Rs1 on under the hybrid driving mode as the state of charge of the battery BAT in the high load section Rs1 is decreased. Accordingly, the control device 20 can maintain the output of the first motor generator MGI in the high load section Rs1, and can prevent, for example, a decrease in the speed of the vehicle 10 due to insufficient output of the first motor generator MGI in the high load section Rs1.

On the other hand, when the control device 20 does not perform the control processing of the driving mode described above, as shown by the thick broken lines in FIG. 4, at the time t11, the hybrid driving mode is not switched, and the vehicle 10 enters the high load section Rs1 still on under the engine driving mode.

In this case, for example, at a time t13 at which the vehicle 10 is passing through the high load section Rs1, the state of charge of the battery BAT reaches the assist lower limit threshold value Pth, and the assist by the first motor generator MG1 is stopped. When the speed of the vehicle 10 cannot be maintained at V1 on under the engine driving mode due to the stop of the assist by the first motor generator MG1, it is necessary to switch to the hybrid driving mode in order to maintain the speed at V1.

In general, at the time of switching from the engine driving mode to the hybrid driving mode, the rotation speed of the engine ENG fluctuates (for example, increases). In particular, in a case where the switching is performed when a load on the vehicle 10 (that is, the required driving force) is large, the rotation speed of the engine ENG more remarkably fluctuates than in a case where the switching is performed when the load on the vehicle 10 is small. Therefore, when switching from the engine driving mode to the hybrid driving mode is performed at the time t13 at which the vehicle 10 is passing through the high load section Rs1, the rotation speed of the engine ENG is rapidly increased, for example (see (B) in FIG. 4). The rapid fluctuation of the rotation speed of the engine ENG caused by the switching from the engine driving mode to the hybrid driving mode is not intended by the driver of the vehicle 10, and the driver easily notices the deterioration of the NV characteristics, and there is a concern that the marketability of the vehicle 10 may he impaired.

In contrast, according to the control device 20, as described above, when the state of charge of the battery BAT in the high load section Rs1 is less than the assist lower limit threshold value Pth, the driving mode of the vehicle 10 can be switched to the hybrid driving mode before the vehicle 10 reaches the high load section Rs1. Therefore, it is possible to prevent the occurrence of a rapid fluctuation in the rotation speed of the engine ENG due to the switching from the engine driving mode to the hybrid driving mode in the high load section Rs1. Accordingly, the deterioration of the NV characteristics of the vehicle 10 can be prevented, and the marketability of the vehicle 10 can be improved.

[Second Example of Specific Control by Control Device]

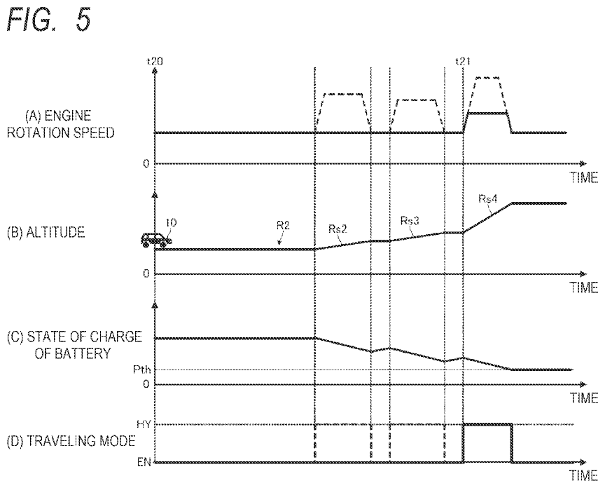

Next, a second example of specific control by the control device 20, which is different from the first example described above, will he described with reference to FIG. 5. In the example shown in FIG. 5, it is assumed that the vehicle 10 travels on a route R2 at a constant speed V2 (for example, 40 [km/h]). Here, the route R2 is a route predicted as a scheduled traveling route of the vehicle 10.

At a time120 at which the vehicle 10 is traveling on the route R2 on under an engine driving mode (shown as driving mode “EN”), the control device 20 detects that high load sections Rs2, Rs3, and Rs4 are present on the route R2 based on the required driving force of each section included in the route R2. Then, the control device 20 determines that a state of charge of the battery BAT in the high load section Rs2 and the high load section Rs3 does not become less than the assist lower limit threshold value Pth. In addition, the control device 20 determines that the required driving force in the high load section Rs2 and the high load section Rs3 is equal to or less than the upper limit output of the engine driving mode.

In this case, the control device 20 maintains the engine driving mode even after the time t20, and causes the vehicle 10 to travel in the high load section Rs2 and the high load section Rs3 still on under the engine driving mode while. As a result, when the vehicle 10 passes through the high load section Rs2 and the high load section Rs3, the switching from the engine driving mode to the hybrid driving mode occurs, and it is possible to prevent the occurrence of the fluctuation in the rotation speed of the engine ENG due to the switching (for example, refer to thick broken lines in portions corresponding to the high load sections Rs2 and Rs3 in (A) and (D) in FIG. 5).

On the other hand, the control device 20 determines that the required driving force of the high load section Rs4 is larger than the upper limit output of the engine driving mode. In this case, the control device 20 switches the driving mode of the vehicle 10 from the engine driving mode to the hybrid driving mode (shown as a driving mode “HY”), for example, at a. time t21 at which the vehicle 10 reaches the high load section Rs4,

Then, the control device 20 performs a control so that all the states of charge of the battery that can be used in the high load section Rs4 are used up, and correspondingly, the electric power required to be generated by the second motor generator MG2 in the high load section Rs4 is reduced as much as possible. As a result, the control device 20 can reduce the rotation speed of the engine ENG in the high load section Rs4 (for example, refer to the thick broken lines of the portion corresponding to the high load section Rs4 in (A) in FIG. 5). Accordingly, it is possible to improve the marketability of the vehicle 10 from the viewpoint of the fuel efficiency, the NV characteristics, and the like.

Although the embodiment of the present invention have been described above, the present invention is not limited to the above embodiment, and modifications, improvements, and the like can be made as appropriate.

In the present specification, at least the following matters are described. Corresponding components in the above embodiment are shown in parentheses. However, the present invention is not limited thereto.

(1) A control device (control device 20) for a vehicle (vehicle 10), the vehicle configured to travel on under a plurality of driving modes, and the vehicle including:

an internal combustion engine (engine ENG);

a power generator (second motor generator MG2) driven by the internal combustion engine and configured to generate electric power;

an electric storage device (battery BAT) configured to store electric power generated by the power generator;

an electric motor (first motor generator MG1) connected to the power generator and the power storage device and configured to drive a drive wheel (drive wheel DW) by electric power supplied from at least one of the power generator and the electric storage device;

the drive wheel that is driven by at least one of the internal combustion engine and the electric motor: and

a disconnection/connection portion (clutch CL) configured to disconnect and connect a power transmission path between the internal combustion engine and the drive wheel, and

the plurality of driving modes including:

a first driving mode (for example, a hybrid driving mode) in which the power transmission path is disconnected by the disconnection/connection portion, and the drive wheel is driven and caused to travel by the power output from the electric motor in accordance with at least the electric power supplied from the power generator; and

a second driving mode (for example, an engine driving mode) in which the power transmission path is connected by the disconnection/connection portion and the drive wheel is driven and caused to travel by at least the power output from the internal combustion engine, wherein

when a high load section (high load section Rs1) in which driving of the drive wheel is assisted by the electric motor is detected on a scheduled traveling route (route R1) of the vehicle traveling on under the second driving mode, a state of charge of the electric storage device in the high load section is predicted, and

switching to the first driving mode is performed before the vehicle reaches the high load section based on the predicted state of charge.

In general, a rotation speed of the internal combustion engine fluctuates when switching from the second driving mode in which the internal combustion engine is used for driving the drive wheel (that is, the internal combustion engine is directly used for traveling of the vehicle) to the first driving mode in which the internal combustion engine is used for driving the power generator (that is, the internal combustion engine is indirectly used for traveling of the vehicle). In particular, in the case where the switching is performed when a load on the vehicle is large, the rotation speed of the internal combustion engine fluctuates more rapidly than in the case where the switching is performed when the load on the vehicle is small. When such a rapid fluctuation in the rotational speed of the internal combustion engine occurs, a driver may feel uncomfortable or NV characteristics may be deteriorated, and the marketability of the vehicle may be deteriorated.

According to (1), when the high load section is detected in the scheduled travel route of the vehicle traveling on under the second driving mode, the state of charge of the electric storage device in the high load section is predicted, the driving mode is switched to the first driving mode before the vehicle reaches the high load section based on the predicted state of charge, and the vehicle can travel in the high load section on under the first driving mode. Accordingly, in the high load section, it is possible to prevent the occurrence of a rapid fluctuation in the rotation speed of the internal combustion engine due to the occurrence of the switching from the second driving mode to the first driving mode, and it is possible to improve the marketability of the vehicle by preventing the deterioration of the NV characteristics.

(2) The control device for a vehicle according to (1), wherein when the predicted state of charge is less than a threshold value (assist lower limit threshold value) that is a condition under which driving assistance of the drive wheel by the electric motor can be executed, switching to the first driving mode is performed.

When the state of charge of the electric storage device in the high load section is less than the threshold value that is a condition under which the driving assistance of the drive wheel by the electric motor can be executed, it is assumed that the driving assistance of the drive wheel by the electric motor cannot be executed during traveling in the high load section. When the driving assistance of the drive wheel by the electric motor cannot be executed while the vehicle is traveling in the high load section on under the second driving mode, the rotation speed of the internal combustion engine may need to be rapidly increased in order to obtain the driving force necessary for traveling of the vehicle.

According to (2), When the state of charge of the electric storage device in the high load section is less than the threshold value which is a condition under which the driving assistance of the drive wheel by the electric motor can be executed, the driving mode can be switched to the first driving mode before the vehicle reaches the high load section, and the vehicle travels in the high load section on under the first driving mode. As a result, in the high load section, it is possible to prevent the occurrence of a rapid fluctuation in the rotation speed of the internal combustion engine due to the fact that the driving assistance of the drive wheel by the electric motor cannot be executed, and it is possible to prevent the deterioration of the NV characteristics.

(3) The control device for a vehicle according to (1) or (2), wherein

when the predicted state of charge is less than the threshold value that is a condition under which the driving assistance of the drive wheel by the electric motor can be executed, a rotation speed of the internal combustion engine is predicted when the vehicle travels in the high load section without the driving assistance, and

switching to the first driving mode is performed based on the predicted rotation speed.

Even when the driving assistance of the drive wheel by the electric motor cannot be executed while the vehicle is traveling in the high load section on under the second driving mode. the rotation speed of the internal combustion engine may not be rapidly increased in order to obtain the driving force necessary for traveling of the vehicle when the load in the high load section is relatively small.

According to (3), when the state of charge of the electric storage device in the high load section is less than the threshold value which is a condition under which the driving assistance of the drive wheel by the electric motor can be executed, it is possible to predict the rotation speed of the internal combustion engine when the vehicle travels in the high load section in a state where the driving assistance by the electric motor is not performed, and to switch to the first driving mode based on the predicted rotation speed. As a result, it is possible to switch to the first driving mode or maintain traveling on under the second driving mode according to the rotation speed of the internal combustion engine when the driving assistance by the electric motor is not performed in the high load section. Therefore, it is possible to cause the vehicle to travel in the high load section on under an appropriate driving mode in accordance with the predicted rotation speed of the internal combustion engine,

(4) The control device for a vehicle according to any one of (1) to (3), wherein when the high load section is detected in the scheduled traveling route, charging of the electric storage device by electric power generated by the power generator is started before the vehicle reaches the high load section.

According to (4), when the high load section is detected in the scheduled traveling route, the charging of the electric storage device by the electric power generated by the power generator is started before the vehicle reaches the high load section, and thus it is possible to secure a large state of charge of the electric storage device in advance when the vehicle travels in the high load section.

(5) The control device for a. vehicle according to any one of (1) to (4), wherein the rotation speed of the internal combustion engine when the vehicle travels in the high load section on under the first driving mode is increased with a decrease in the state of charge of the electric storage device in the high load section.

According to (5), the rotation speed of the internal combustion engine can be gradually increased in accordance with the decrease in the state of charge of the electric storage device in the high load section, so that the output of the electric motor in the high load section can be maintained.

(6) The control device for a vehicle according to (1), wherein when the predicted state of charge is equal to or greater than the threshold value that is a condition under which the driving assistance of the drive wheel by the electric motor can be executed, the vehicle travels in the high load section on under the second driving mode.

According to (6), when the state of charge of the electric storage device in the high load section is equal to or greater than the threshold value that is a condition under which the driving assistance of the drive wheel by the electric motor can be executed, the vehicle can travel in the high load section in the second driving mode. Accordingly, when the driving assistance by the electric motor can be continued in the high load section, the vehicle can travel in the high load section while maintaining the second driving mode, and the deterioration of the NV characteristics due to the driving mode switching can be prevented to improve the marketability of the vehicle.

(7) The control device for a vehicle according to (1), wherein

when the predicted state of charge is equal to or greater than the threshold value that is a condition under which the driving assistance of the drive wheel by the electric motor can be executed, whether an upper limit output that can be output by the vehicle in the second. driving mode is equal to or greater than a required driving force required during traveling in the high load section is determined, and

when the upper limit output is less than the required driving force, the vehicle travels in the high load section on under the first driving mode, and the rotation speed of the internal combustion engine at the time of causing the vehicle to travel in the high load section on under the first driving mode is set based on the state of charge.

According to (7), even when the state of charge of the electric storage device in the high load section is equal to or greater than the threshold value that is a condition under which the driving assistance of the drive wheel by the electric motor can be executed, it is possible to cause the vehicle to travel in the high load section on under the first driving mode when the upper limit output that can be output by the vehicle in the second driving mode is less than the required driving force required during traveling in the high load section. As a result, it is possible to prevent shortage of the driving force required for traveling of the vehicle in the high load section. In addition, the rotation speed of the internal. combustion engine when the vehicle is caused to travel in the high load section in the first driving mode can he set based on the state of charge of the electric storage device in the high load section. Thus, the rotation speed of the internal combustion engine when the vehicle is caused to travel in the high load section can be reduced in accordance with the state of charge of the electric storage device in the high load section.

What is claimed is:

1. A control device for a vehicle, the vehicle configured to travel on under a plurality of driving modes, and the vehicle including:
an internal combustion engine;
a power generator driven by the internal combustion engine and configured to generate electric power;
an electric storage device configured to store electric power generated by the power generator:
an electric motor connected to the power generator and the electric storage device and configured to drive a drive wheel by electric power supplied from at least one of the power generator and the electric storage device;
the drive wheel driven by at least one of the internal combustion engine and the electric motor; and
a disconnection/connection portion configured to disconnect and connect a power transmission path between the internal combustion engine and the drive wheel, and.
the plurality of driving modes including:
a first driving mode in which the power transmission path is disconnected by the disconnection/connection portion, and the drive wheel is driven and caused to travel by the power output from the electric motor at least in accordance with the electric power supplied from the power generator; and
a second driving mode in which the power transmission path is connected by the disconnection/connection portion and the drive wheel is driven and caused to travel by at least the power output from the internal combustion engine, wherein
when a high load section in which driving of the drive wheel is assisted by the electric motor is detected in a scheduled traveling route of the vehicle traveling on under the second driving mode, a state of charge of the electric storage device in the high load section is predicted, and
switching to the first driving mode is performed before the vehicle reaches the high load section based on the predicted state of charge.

2. The control device for a vehicle according to claim 1, wherein when the predicted state of charge is less than a threshold value that is a condition under which driving assistance of the drive wheel by the electric motor can be executed, switching to the first driving mode is performed.

3. The control device fir a vehicle according to claim 1, wherein
when the predicted state of charge is less than the threshold value that is a condition under which the driving assistance of the drive wheel by the electric motor can be executed, a rotation speed of the internal combustion engine is predicted when the vehicle travels in the high load section without the driving assistance, and
switching to the first driving mode is performed based on the predicted rotation speed.

4. The control device for a vehicle according to claim 1, wherein when the high load section is detected in the scheduled traveling route, charging of the electric storage device by electric power generated by the power generator is started before the vehicle reaches the high load section.

5. The control device for a vehicle according to claim 1, wherein the rotation speed of the internal combustion engine when the vehicle travels in the high load section on under the first driving mode is increased with a decrease in the state of charge of the electric storage device in the high load section.

6. The control device for a vehicle according to claim 1, wherein when the predicted state of charge is equal to or greater than the threshold value that is a condition under which the driving assistance of the drive wheel by the electric motor can be executed, the vehicle travels in the high load section on under the second driving mode.

7. The control device for a vehicle according to claim 1, wherein
when the predicted state of charge is equal to or greater than the threshold value that is a condition under which the driving assistance of the drive wheel by the electric motor can be executed, whether an upper limit output that can be output by the vehicle in the second driving mode is equal to or greater than a required driving force required during traveling in the high load section is determined, and
when the upper limit output is less than the required driving force, the vehicle travels in the high load section on under the first driving mode, and the rotation speed of the internal combustion engine at the time of causing the vehicle to travel in the high load section on under the first driving mode is set based on the state of charge.
